(19) United States
(12) Patent Application Publication
(10) Pub. No.: US 2007/0286527 A1
(43) Pub. Date: Dec. 13, 2007

(54) SYSTEM AND METHOD OF DETERMINING THE EXPOSED FIELD OF VIEW IN AN X-RAY RADIOGRAPH

(75) Inventors: Kadri Nizar Jabri, Waukesha, WI (US); Renuka Uppaluri, Pewaukee, WI (US); Yogesh Srinivas, Hartland, WI (US); Karthik Kumar Krishnakumar, Waukesha, WI (US)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/843,907

(22) Filed: Aug. 23, 2007

Related U.S. Application Data
(63) Continuation-in-part of application No. 11/023,244, filed on Dec. 24, 2004.
(60) Provisional application No. 60/947,180, filed on Jun. 29, 2007.

(51) Int. Cl. G06K 9/36

(52) U.S. Cl. 382/286

(57) ABSTRACT

A system and method of determining the exposed field of view of a radiography image based on various parameters such as image content data, positioner feedback data, or any combination thereof, with no need for user intervention.

### CROSS-REFERENCE TO RELATED APPLICATIONS

This application is based on and claims the benefit of U.S. Provisional Patent Application No. 60/947,180, filed Jun. 29, 2007, and is also a continuation-in-part of and claims priority to U.S. patent application Ser. No. 11/023,244, filed Dec. 24, 2004, the disclosures of which are incorporated herein by reference.

### BACKGROUND OF THE INVENTION

This disclosure relates generally to X-ray systems and methods, and more particularly to a system and method of determining the exposed field of view in an X-ray radiograph.

In an X-ray or digital radiography system, an X-ray beam is generated from an X-ray source and projected through a subject to be imaged onto an X-ray detector. Between the X-ray source and the X-ray detector is a collimator that defines and restricts the dimensions and direction of the X-ray beam from the X-ray source onto the X-ray detector.

The image projected onto the X-ray detector has edges that define the outer perimeter of the image. The image is processed by a processor that is part of a system controller of the X-ray or digital radiography system. Examples of the processing include enhancing the image and adding labels in the image. The processor looks for data describing the location of edges of the image based on collimator coordinates and collimation edges in order to limit the processing of the image beyond the edges.

In some conventional integrated X-ray or digital radiography systems, collimation edge localization and image cropping algorithms are usually based on feedback obtained from a positioner, a mechanical controller of the X-ray source and collimator. In some implementations, a positioner is integrated into a fixed X-ray system, but provides no feedback data on the collimator coordinates and collimation edges. In other implementations, feedback data from the positioner is completely unavailable such as in mobile or portable radiography systems because the image processing chain is not usually integrated with the positioner and therefore has no knowledge of the collimator coordinates and collimation edges. In these conventional integrated X-ray or digital radiography systems, the positioner provides somewhat less than precise data on the location of the collimator coordinates and collimation edges. Image-based collimation edge localization and image cropping algorithms are used on radiography systems where positioner feedback is limited or unavailable.

Some newer premium radiography systems may have a portable detector along with one or more fixed detectors. In such systems, positioner feedback may be available for some images but not for others. Since each approach of using an image-based algorithm or a hardware-based algorithm to determine the exposed field of view in an X-ray radiograph has both its advantages and disadvantages, relying solely on either the image-based algorithm or the hardware-based algorithm to determine the exposed field of view is not optimal.

Therefore, there is a need in the art for more precisely determining the exposed field of view in an X-ray radiograph using both an image-based algorithm and a hardware-based positioner feedback algorithm. (positioner feedback-based algorithm)

### BRIEF DESCRIPTION OF THE INVENTION

In an embodiment, a method for determining a field of view for a radiography image, the method comprising acquiring an image; determining a field of view for the acquired image using image content data; processing the acquired image based on the determined field of view; and cropping the processed image to fit the determined field of view.

In an embodiment, a method for determining a field of view for a radiography image, the method comprising acquiring an image; determining a field of view for the acquired image using positioner feedback data; processing the acquired image based on the determined field of view; and cropping the processed image to fit the determined field of view.

In an embodiment, a method for determining a field of view for a radiography image, the method comprising acquiring an image determining a field of view for the image using image content data and positioner feedback data; processing the acquired image based on the determined field of view; and cropping the processed image to fit the determined field of view.

In an embodiment, a method for determining a field of view for a radiography image, the method comprising acquiring an image; determining collimator coordinates for the acquired image using image content data; determining collimator coordinates for the acquired image using positioner feedback data; determining collimator coordinates for the acquired image using image content data and positioner feedback data; selecting the collimator coordinates from the image content data, positioner feedback data, or a combination thereof; processing the acquired image based on the selected collimator coordinates.

In an embodiment, a method of determining the exposed field of view in a radiography system that includes an X-ray source, a detector, and a positioner, the method comprising acquiring an image of a subject using the radiography system including the X-ray source, the detector and the positioner; determining collimator coordinates for the acquired image based on one of image content data, positioner feedback data, and image content data and positioner feedback data; using a set of rules for selecting the appropriate method of determining collimator coordinates; and identifying the field of view and processing the image based on the determined collimator coordinates.

In an embodiment, a radiography system for determining a field of view for an image, the system comprising an X-ray source; a detector; a collimator adjacent to the X-ray source, and between the X-ray source and the detector; a positioner coupled to the X-ray source and the collimator for controlling the positioning of the X-ray source and the collimator; an image processor configured to process image data to generate a processed image, wherein the image processor determines a field of view for the image data based on image content data, positioner feedback data from the positioner, or any combination thereof for use in generating the processed image.

In an embodiment, a system for determining a field of view for an image, the system comprising an image processor configured to process image data to generate a processed image, wherein the image processor determines a field of view for the image data based on image content data, positioner feedback data, or any combination thereof for use in generating the processed image.

In an embodiment, a computer-readable storage medium including a set of instructions for a computer, the set of instructions comprising an image processing routine configured to process image data to generate a processed image, wherein the image processor determines a field of view for the image data based on image content data, positioner feedback data, or any combination thereof for use in generating the processed image.

Various other features, objects, and advantages will be made apparent to those skilled in the art from the accompanying drawings and detailed description thereof.

### BRIEF DESCRIPTION OF THE DRAWINGS

FIG. 1 is a block diagram of an exemplary embodiment of a radiography system;

FIG. 2 is a flow diagram of an exemplary embodiment of a radiography system to determine the exposed field of view in an X-ray radiograph;

FIG. 3 is a flow diagram of an exemplary embodiment of a radiography system to determine the exposed field of view in an X-ray radiograph;

FIG. 4 is a flow diagram of an exemplary embodiment of a method for detecting an edge of an image;

FIG. 5 is a flow diagram of an exemplary embodiment of a method for locating a plurality of candidate collimation edges;

FIG. 6 is a flow diagram of an exemplary embodiment of a method for selecting one peak in each of the projection-space images for each side;

FIG. 7 is a flow diagram of an exemplary embodiment of a method for selecting candidate peaks;

FIG. 8 is a flow diagram of an exemplary embodiment of a method for determining the validity of each of the candidate collimation edges;

FIG. 9 is a flow diagram of an exemplary embodiment of a method for testing the validity of a candidate collimation edge;

FIG. 10 is a flow diagram of an exemplary embodiment of a method to determine the exposed field of view in an X-ray radiograph;

FIG. 11 is a flow diagram of an exemplary embodiment of a method to determine the exposed field of view in an X-ray radiograph;

FIG. 12 is a flow diagram of an exemplary embodiment of a method to determine the exposed field of view in an X-ray radiograph;

FIG. 13 is a flow diagram of an exemplary embodiment of a method to determine the exposed field of view in an X-ray radiograph; and

FIG. 14 is a block diagram of an exemplary embodiment of an image processing system capable of processing an image and determining the image's field of view.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

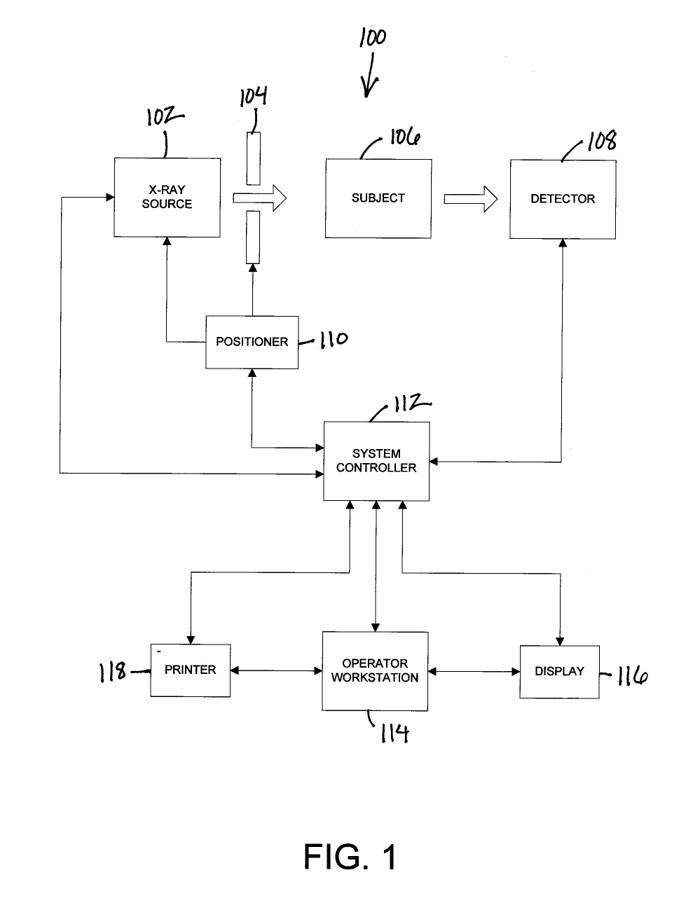

Referring now to the drawings, FIG. 1 illustrates a block diagram of an exemplary embodiment of a radiography system 100. The system 100 is configured for determining the exposed field of view of an image generated by the radiography system. The radiography system 100 includes an X-ray source 102, a collimator 104 adjacent to the X-ray source 102, a subject 106 to be imaged, a detector 108, and a positioner 110. The positioner 110 is a mechanical controller coupled to X-ray source 102 and collimator 104 for controlling the positioning of X-ray source 102 and collimator 104.

The radiography system 100 is designed to create images of the subject 106 by means of an X-ray beam 120 emitted by X-ray source 102, and passing through collimator 104, which forms and confines the X-ray beam to a desired region, wherein the subject 106, such as a human patient, is positioned. A portion of the X-ray beam 120 passes through or around the subject 106, and being altered by attenuation and/or absorption by tissues within the subject 106, continues on toward and impacts the detector 108. In an exemplary embodiment, the detector 108 may be a digital flat panel detector. The detector 108 converts X-ray photons received on its surface to lower energy photons, and subsequently to electric signals, which are acquired and processed to reconstruct an image of internal anatomy within the subject 106.

In an exemplary embodiment, the radiography system 100 may be digital radiography system. In an exemplary embodiment, the radiography system 100 may be tomosynthesis radiography system. In some exemplary embodiments, the radiography system 100 may include both fixed detectors as well as portable detectors (for cross table and extremity imaging).

The radiography system 100 further includes a system controller 112 coupled to X-ray source 102, positioner 110, and detector 108 for controlling operation of the X-ray source 102, positioner 110, and detector 108. The system controller 112 may supply both power and control signals for imaging examination sequences. In general, system controller 112 commands operation of the radiography system to execute examination protocols and to process acquired image data. The system controller 112 may also include signal processing circuitry, based on a general purpose or application-specific computer, associated memory circuitry for storing programs and routines executed by the computer, as well as configuration parameters and image data, interface circuits, and so forth.

The system controller 112 may further include at least one processor designed to coordinate operation of the X-ray source 102, positioner 110, and detector 108, and to process acquired image data. The at least one processor may carry out various functionality in accordance with routines stored in the associated memory circuitry. The associated memory circuitry may also serve to store configuration parameters, operational logs, raw and/or processed image data, and so forth. In an exemplary embodiment, the system controller 112 includes at least one image processor to process acquired image data.

The system controller 112 may further include interface circuitry that permits an operator or user to define imaging sequences, determine the operational status and health of system components, and so-forth. The interface circuitry may allow external devices to receive images and image data, and command operation of the radiography system, configure parameters of the system, and so forth.

The system controller 112 may be coupled to a range of external devices via a communications interface. Such devices may include, for example, an operator workstation 114 for interacting with the radiography system, processing or reprocessing images, viewing images, and so forth. In the case of tomosynthesis systems, for example, the operator workstation 114 may serve to create or reconstruct image slices of interest at various levels in the subject based upon the acquired image data. Other external devices may include a display 116 or a printer 118. In general, these external devices 114, 116, 118 may be local to the image acquisition components, or may be remote from these components, such as elsewhere within a medical facility, institution or hospital, or in an entirely different location, linked to the image acquisition system via one or more configurable networks, such as the Internet, intranet, virtual private networks, and so forth. Such remote systems may be linked to the system controller 28 by any one or more network links. It should be further noted that the operator workstation 114 may be coupled to the display 118 and printer 118, and may be coupled to a picture archiving and communications system (PACS). Such a PACS might be coupled to remote clients, such as a radiology department information system or hospital information system, or to an internal or external network, so that others at different locations may gain access to image data.

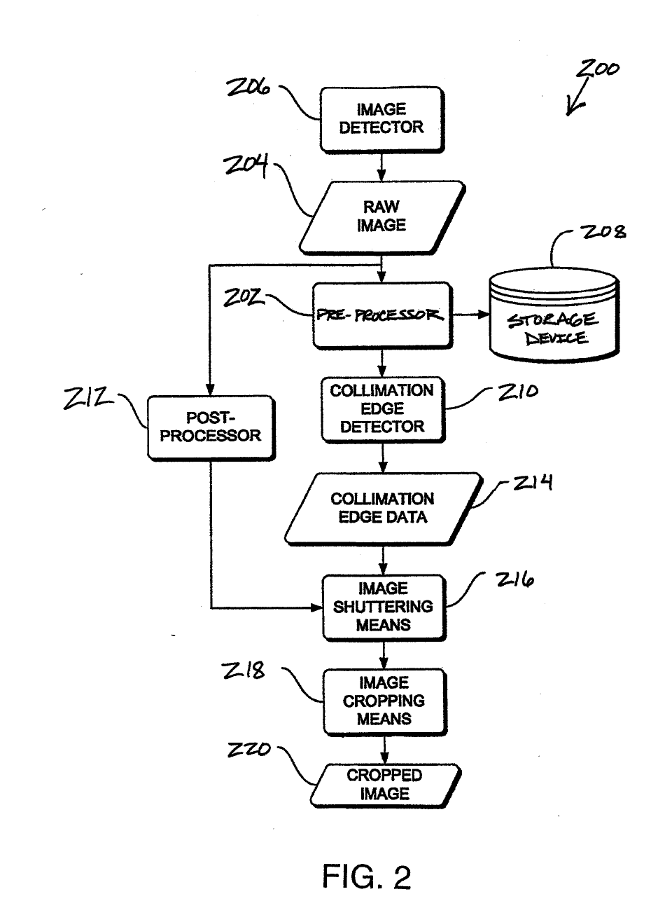

FIG. 2 is a flow diagram of an exemplary embodiment of a radiography system 200 to determine the exposed field of view in an X-ray radiograph. System 200 includes a pre-processor 202. The pre-processor 202 is operable to receive a raw input image 204 from an image detector 206. The pre-processor 202 is operable to store the raw input image 204 on a storage device 208. System 200 also includes a collimation edge detector 210 operable to detect collimation edges in the raw input image 204 and a post-processor 212 of the raw input image 204. The collimation edge detector 210 generates collimation edge data 214 that represents or describes the location of the collimation edges in the raw input image 204. The collimation edge detector 210 can be incorporated, implemented or included in any radiography system where the raw image 204 is available as an input. System 200 also includes an image shuttering means 216 that shutters a post-processed image in reference to the collimation edge data 214 generated by the collimation edge detector 210. System 200 further includes an image cropping means 218 that crops a shuttered image in reference to the collimation edge data 214 generated by the collimation edge detector 210. The image cropping means 118 provides a cropped image 220. The cropped image 220 is produced at least in part, if not entirely, in reference to the collimation edge data 214 extracted or derived from the pre-processed raw image 204.

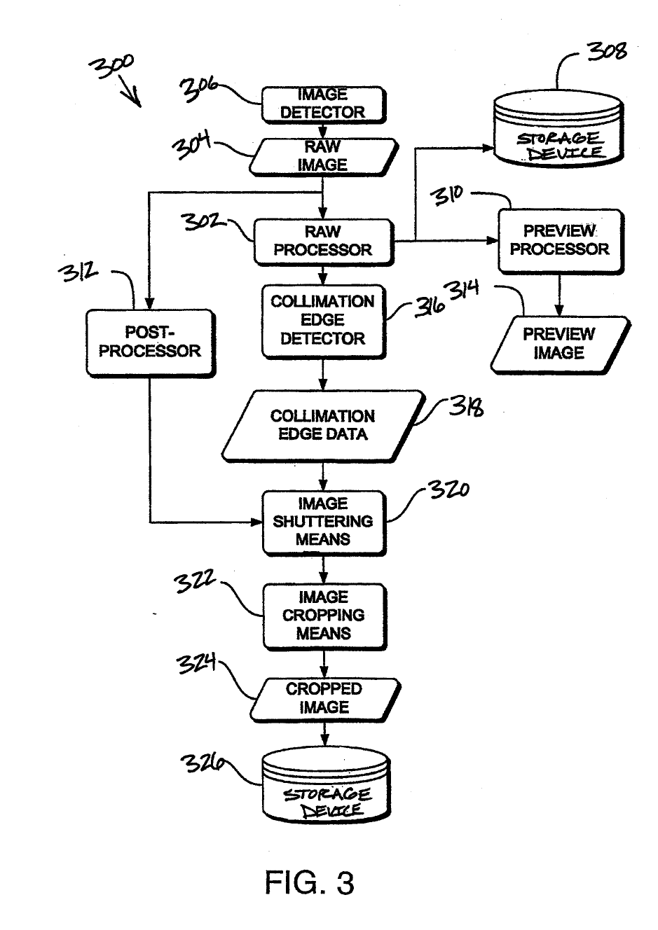

FIG. 3 is a flow diagram of an exemplary embodiment of a radiography system 300 to determine the exposed field of view in an X-ray radiograph. System 300 includes a raw processor 302 that performs operations on a raw image 304, such as correcting for detector gain variations, image rotation, and/or image flip on the raw image 304, as well as other processes. The raw processor 302 is also operable to store the raw image 304 on a storage device 308 in the same form as the raw image 304 is received from the image detector 306. Moreover, the raw processor 302 is also operable to transmit the raw image 304 to a preview processor 310 that provides a preview image 314. System 300 also includes a collimation edge detector 316 operable to detect collimation edges in the raw image 304, and generate collimation edge data 318 that identifies collimator coordinates and collimation edges. System 300 further includes a post-processor 312 of the raw image 304. Post-processing may include operations such as edge enhancement, dynamic range management and automated optimization of image brightness/contrast display settings. System 300 also includes image shuttering means 320 that shutters a post-processed image in reference to the collimator coordinates and collimation edges detected by the collimation edge detector 316. In an exemplary embodiment, the image shuttering means 320 is performed by manual shutter adjustment. The system 300 also includes an image cropping means 322 that crops a shuttered image in reference to the collimation edge data 318. The shuttered image is cropped to an area enclosed by the field of view detected by the collimation edge detector 316. The image cropping means 322 provides the cropped image 324. The cropped image 324 is produced at least in part, if not entirely, in reference to the collimation edge data 318 extracted or derived from the pre-processed raw image 304. In an exemplary embodiment, system 300 also includes a storage device 326 on which the cropped image is stored.

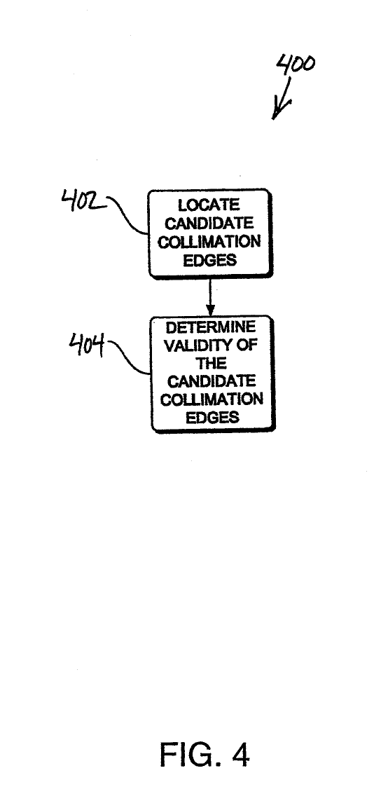

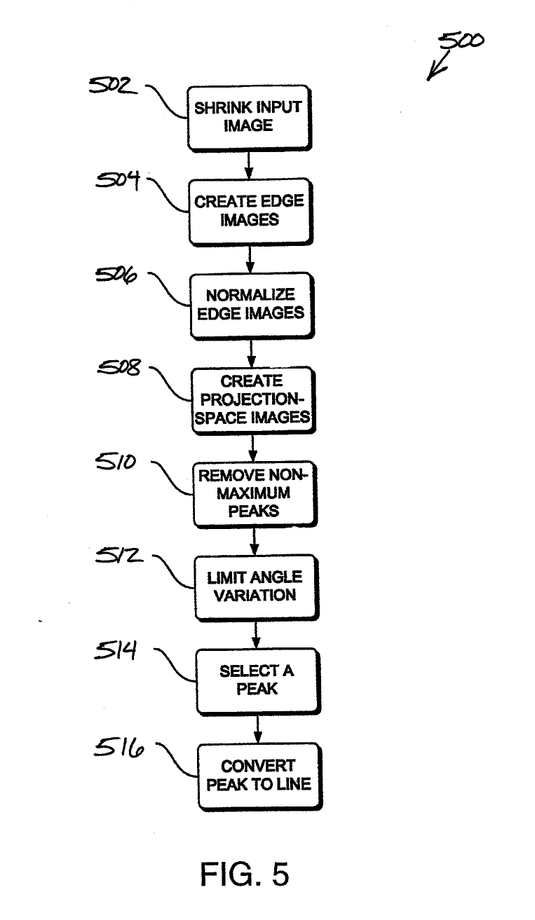

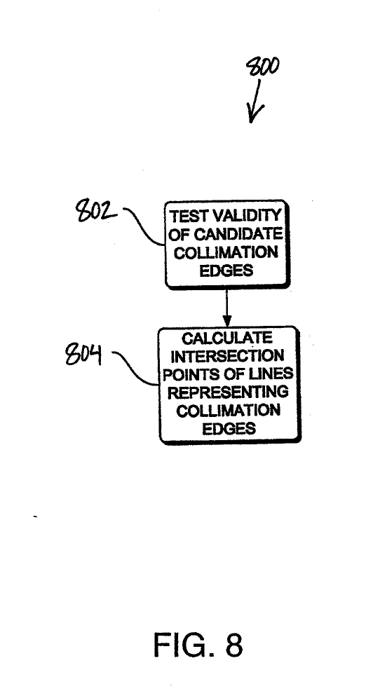

FIG. 4 is a flow diagram of an exemplary embodiment of a method 400 for detecting an edge of an image. Method 400 includes locating 402 a plurality of candidate collimation edges in a plurality of projected edge images. In an exemplary embodiment, the step of locating 402 a plurality of candidate collimation edges includes creating a plurality of projection images from collimation edge data of a raw image. The raw image is obtained after applying corrections to detector data referred to as pre-processing in FIG. 2. The plurality of projected edge images being associated with at least one indication of image intensity. In an exemplary embodiment, the step of locating 402 a plurality of candidate collimation edges in a plurality of projected edge images is outlined in FIG. 5. In an exemplary embodiment, the step of locating 402 a plurality of candidate collimation edges in a plurality of projected edge images includes invoking an evidence-based process to locate the plurality of candidate collimation edges in the plurality of projection images. The method 500 in FIG. 5 is an example of an evidence-based process. Method 400 also includes determining 404 the validity of each of the candidate collimation edges. The determining 404 is performed in reference to a statistical analysis of the at least one indication of image intensity. In an exemplary embodiment, the step of the determining 404 the validity of each of the candidate collimation edges is outlined in FIG. 8.

FIG. 5 is a flow diagram of an exemplary embodiment of a method 500 for locating a plurality of candidate collimation edges. Method 500 is one embodiment of locating 402 a plurality of candidate collimation edges in a plurality of projected edge images discussed in FIG. 4. Method 500 includes shrinking 502 an input image, such as raw image 204 in FIG. 2. In an exemplary embodiment, shrinking is reducing the physical size of a raw image 204, for example, reducing a raw image having 2000 by 2000 pixels to a raw image having 500 by 500 pixels. In an exemplary embodiment, the shrinking 502 is performed using the nearest-neighbor interpolation method, in which no pixel averaging is used. The input to a component that performs the shrinking includes a detector-corrected (un-cropped) image, such as raw image 204 named M. An output of the component is a shrunken image. One of the input parameters is an image shrink factor, an integer named SHRINK, having a range of enumerated values (e.g. 2, 4, 8, and 16).

Method 500 subsequently includes creating 504 a plurality of edge images for each side of the shunken input image. In an exemplary embodiment, the step of creating 504 a plurality of edge images includes creating four edge images by convolving the input image M 204 with the corresponding kernels: 1) Collimator down (CD) image: M is convolved with kernel 1; 2) Collimator up (CU) image: M is convolved with kernel 2; 3) Collimator right (CR) image: M is convolved with kernel 3; and 4) Collimator left (CL) image: M is convolved with kernel 4. The above four kernels are formed by extending the Sobel kernel. The vertical Sobel filter kernel is shown below in Table 1:

TABLE 1

| | | |
|---|---|---|
| 1 | 2 | 1 |
| 0 | 0 | 0 |
| −1 | −2 | −1 |

In Table 1, the Sobel kernel is extended to detect collimation edges.

A kernel shown is Table 2 below is used to emphasize the horizontal edge for the collimator down image:

TABLE 2

| | | |
|---|---|---|
| 1 | 2 | 1 |
| 1 | 2 | 1 |
| 1 | 2 | 1 |
| 1 | 2 | 1 |
| 0 | 0 | 0 |
| −1 | −2 | −1 |
| −1 | −2 | −1 |
| −1 | −2 | −1 |
| −1 | −2 | −1 |

An edge image for the collimator down image is created in reference to Table 2. The kernel used to detect the edge of collimator down image is simply flipped upside down, to detect the edge of the collimator up image.

TABLE 3

| | | |
|---|---|---|
| −1 | −2 | −1 |
| −1 | −2 | −1 |
| −1 | −2 | −1 |
| −1 | −2 | −1 |
| 0 | 0 | 0 |
| 1 | 2 | 1 |
| 1 | 2 | 1 |
| 1 | 2 | 1 |
| 1 | 2 | 1 |

An edge image is created for an upper collimation edge in reference to Table 3. To detect edges for collimator right and collimator left images, the kernels used for collimator up and collimator down images are transposed, as shown in Table 4 and Table 5 below, respectively:

TABLE 4

| | | | | | | | | |
|---|---|---|---|---|---|---|---|---|
| 1 | 1 | 1 | 1 | 0 | −1 | −1 | −1 | −1 |
| 2 | 2 | 2 | 2 | 0 | −2 | −2 | −2 | −2 |
| 1 | 1 | 1 | 1 | 0 | −1 | −1 | −1 | −1 |

An edge image is created for a right side collimation edge in reference to Table 4.

TABLE 5

| | | | | | | | | |
|---|---|---|---|---|---|---|---|---|
| −1 | −1 | −1 | −1 | 0 | 1 | 1 | 1 | 1 |
| −2 | −2 | −2 | −2 | 0 | 2 | 2 | 2 | 2 |
| −1 | −1 | −1 | −1 | 0 | 1 | 1 | 1 | 1 |

An edge image is created for a left side collimation edge in reference to Table 5.

Before convolution, raw image M 104 is mirror-padded, in which input array values outside the bounds of the array are computed by mirror-reflecting the array across the array border. After convolution, the extra “padding” is discarded and the resulting edge images are therefore the same size as that of raw image M 104.

In an exemplary embodiment, creating 504 a plurality of edge images is performed by a component that receives the shrunken image, and generates four edge images, named CD, CU, CR, and CL. Thereafter the edge images of each side of the shrunken input image are normalized 506. In an exemplary embodiment of normalizing 506, the raw image 204 is mirror-padded and thereafter convolved with a Gaussian low pass kernel to generate a low pass (blurred) image named BM. The window size for this kernel is defined by a parameter named GBlurkernel, while the standard deviation (sigma) is defined by a parameter GBlurSigma. Thereafter each pixel of each edge is divided by BM in order to create the corresponding normalized edge image that can be name NCD, NCU, NCR and NCL. In this embodiment, a component that performs the normalizing actions receives edge images named CD, CU, CR, and CL and generates corresponding normalized edge images named NCD, NCU, NCR, and NCL. Parameters of the component include GBlurKernel, which represents a square window size (in pixels) of the Gaussian kernel that is an integer having a range of 0 to 15 and parameter GblurSigma, which represents a standard deviation (in pixels) of the Gaussian kernel that is an integer having a range of 0 to 5.

Subsequently, method 500 includes creating 508 a plurality of projection-space images for each side of the shrunken input image. In an exemplary embodiment, the step of creating 308 the projection-space images includes performing a Radon transform operation with an angle range of between 0 degrees and 179 degrees. In this embodiment, four projection-space images named PCD, PCU, PCR, and PCL corresponding to the normalized edge images NCD, NCU, NCR and NCL are created using the Radon transform operation. Furthermore, each column of a projection-space image is a projection (sum) of the intensity values along the specified radial direction (oriented at a specific angle). In an exemplary embodiment, the continuous form of the Radon transform is shown in Table 6 below:

TABLE 6
$\begin{matrix}{R}_{θ} ( {x}^{′} ) = {\int }_{- ∞}^{∞} f ( {x}^{′} cos θ - {y}^{′} sin θ , {x}^{′} sin θ + {y}^{′} cos θ ) ⅆ {y}^{′} where , \\ [ \begin{matrix}{x}^{′} \\ {y}^{′}\end{matrix} ] = [ \begin{matrix}cos θ & sin θ \\ - sin θ & - cos θ\end{matrix} ] [ \begin{matrix}x \\ y\end{matrix} ]\end{matrix}$

In Table 5, the Radon transform of f(x,y) is the line integral of f parallel to the y′-axis. The center of this projection is the center of the image. The Radon transform is always performed with the angle range of 0° to 179°. The angle interval (difference between two consecutive projection angles) is defined by a parameter named AngleStep. Therefore, the number of columns in each projection-space image is equal to the angle range divided by the angle interval/step. In this embodiment, a component that creates 508 a plurality of projection-space images receives normalized edge images, NCD, NCU, NCR, and NCL and generates corresponding projection-space images, PCD, PCU, PCR and PCL. The component includes a parameter named AngleStep which specifies a step size between consecutive projection angles that is an integer having a range of 1 to 5.

Method 500 also includes removing 510 local non-maximum peaks in each of the projection-space images for each side of the shrunken input image. In some exemplary embodiments, the step of removing 310 the local non-maximum peaks includes setting a pixel having a non-maximum magnitude in a selected window to zero. In these embodiments, in every projection-space image, the local non-maximum peaks are removed to account for the potential effects of noise. For every projection-space image (e.g. PCD, PCU, PCR, and PCL), a corresponding new projection-space (e.g. MPCD, MPCU, MPCR, and MPCL) image is created. Where the projection space image is named P and the new projection space image is named P′, for every pixel in the projection space image P(x,y), a square window around it is selected. The size of this window is defined by the NMSkernel parameter (in pixels). For image pixels on the image edges, zero padding is implemented. If the pixel P (x,y) has the maximum magnitude in the selected window then pixel P′(x,y) is equal to P (x,y), otherwise pixel P′(x,y) is set to a value of zero.

In these embodiments, a component that removes the local non-maximum peaks by setting a pixel having a non-maximum magnitude in a selected window to zero the component receives projection-space images, PCD, PCU, PCR, and PCL, and generates projection-space images with non-maximum peaks removed MPCD, MPCU, MPCR, and MPCL. Parameters of the component include NMSkernel that defines square kernel size of the filter, NMSkernel being of type integer and having a range from 1 to 15.

Thereafter, method 500 includes limiting 512 an angle variation in each of the projection-space images for each side of the shrunken input image. In some exemplary embodiments of limiting 512, in every projection-space image, one column corresponds to one angle theta (where the angle varies from 0° to 179°). A data structure designated as MPCD that represents columns corresponding to 0° to 45° and 136° to 179° are set to zero, a data structure designated as MPCU: columns corresponding to 0° to 45° and 136° to 179° are set to zero, a data structure designated as MPCR that represents columns corresponding to 46° to 135° are set to zero, a data structure designated as MPCL that represents columns corresponding to 46° to 135° are set to zero.

In these embodiments, a component that limits the angle variation in each of the projection-space images for each side of the shrunken input image receives projection-space images with non-maximum peaks removed, designated MPCD, MPCU, MPCR, and MPCL and generates projection-space images designates as MPCD, MPCU, MPCR, and MPCL with angle limitation applied. The component includes a parameter designated as MarkerThresh which specifies which range of angles will be limited.

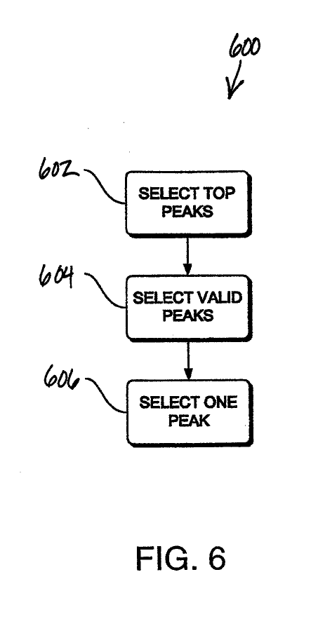

Thereafter one peak in each of the projection-space images for each side is selected 514. An exemplary embodiment of selecting 514 is shown in FIG. 6.

In some exemplary embodiments, collimation edges in image space are usually indicated by a compact peak with high magnitude in the projection-space image. A magnitude of a peak in the projection-space image is related to the length of the corresponding straight edge in image space. Compactness of a peak in the projection-space image indicates the extent of linearity of the corresponding straight edge in image space. Compactness is determined with an area measure as explained below. The lower the area measure is, the more compact is the peak considered. A threshold is set for both the area of a peak as well as the magnitude of the peak in order to discount spurious peaks due to noise or anatomy.

Method 500 also includes converting 516 peak coordinates in the projection-space images are to line equations corresponding to collimation edges in image intensity. Some embodiments of converting 516 peak coordinates include calculating Cartesian coordinate equations in the image intensity.

In some exemplary embodiments of converting 516 peak coordinates, coordinates of the four peaks selected in selecting 514, one peak in each of projection-space image, is used to calculate the radial coordinates in the image space. These four selected peaks in the projection-space image correspond to four dominant straight edges in the image space. These lines are the candidate collimation edges. The theta values and the distances of each line from the origin are calculated. These values represent a line in the following equation in Table 7 below:

TABLE 7
S = Acosθ + Bsinθ

In Table 6, Cartesian coordinate equations in the image space are calculated for the four candidate collimation edge lines.

In some exemplary embodiments, converting 516 peak coordinates is performed by a component that receives four selected peaks designated as PeakCD, PeakCU, PeakCR, and PeakCL from projection-space image corresponding to dominant edges in the image space. The component generates line equations in image space for the four candidate collimation edges that are Cartesian coordinates.

Some exemplary embodiments of method 500 make use of the fact that a compact peak, with high magnitude in a projection-space represents a collimation edge in image space. Magnitude of a peak in the projection-space image is related to length of the corresponding straight edge in image space. Compactness is determined with an area measure. In this process, first normalized edge images for each collimator region is formed. Thereafter projection space images are created using the Radon transform. The most compact peak with high magnitude is identified in projection space, which is then converted to a candidate line in image space. Candidate lines are then tested using image space statistics to confirm whether they are true collimation edges.

Thereafter in some exemplary embodiments, intersection points of all collimation edges are calculated in order to define the vertices of the collimated region in the image. The Intersection points are designated as P1, P2, P3 and P4. Subsequently, in some exemplary embodiments, method 500 performs optimally when the collimator has at most four blades/edges, when the collimation edges are straight (circular or custom-shape collimation is not explicitly detected), and when the collimated regions (low signal/counts), whenever present, are in the image periphery (patient shielding is not explicitly detected).

Input data to method 500 is the input image that is obtained after detector corrections. Output of method 500 includes vertices of the polygonal (4 sides) collimated region in the input image. In the situation where a collimation edge is not present, the edge of the image is designated as the collimation edge.

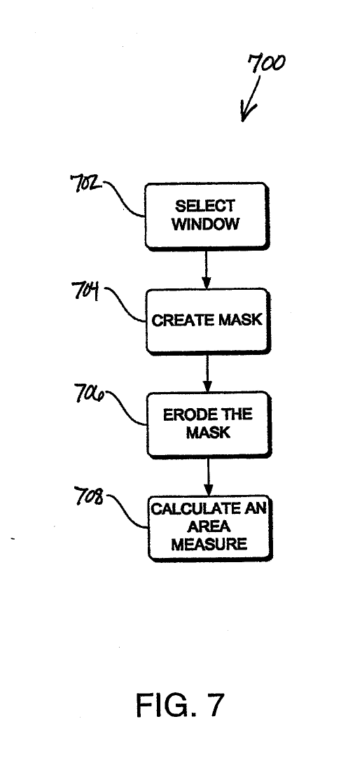

FIG. 6 is a flow diagram of an exemplary embodiment of a method 600 for selecting one peak in each of the projection-space images for each side. Method 600 is one exemplary embodiment of selecting 514 a peak discussed in FIG. 5. Method 600 includes selecting 602 top candidate peaks. In an exemplary embodiment, the top five candidate peaks are selected. An exemplary embodiment of selecting 602 top candidate peaks is shown in FIG. 7 below. Method 600 also includes selecting 604 valid peaks from the selected top candidate peaks of step 602. In some exemplary embodiments, the step of selecting 604 valid peaks from among the peaks selected in step 602 includes selecting valid peaks depending on, if for each peak: 1) all the pixels in the mask (with mask value of 1) have projection-space image magnitudes lesser than that of the peak itself; 2) the projection-space image magnitude of a given peak is greater than (MaxPspace×projspacethreshold) where MaxPspace is the maximum magnitude in the projection-space image and projspacethreshold is a parameter; and 3) the area measure (in pixels) is less than the area threshold parameter areathreshold.

Method 600 also includes selecting 606 a peak corresponding to a most dominant straight edge. In some exemplary embodiments of selecting 406 a peak corresponding to the most dominant edge, for each projection-space image, the peak with the minimum area (from the valid peaks selected in the previous step) is identified as corresponding to a candidate collimation edge. The coordinates of this peak in the projection-space are thereafter stored. For a component the selects a peak corresponding to the most dominant edge, the component receives projection-space images with non-maximum peaks removed and angle restriction applied to, designated as NPCD, NPCU, NPCR, and, NPCL, and also receives projection-space images PCD, PCU, PCR, and PCL. The component generates coordinates of four identified peaks in the projection-space images, one in each projection-space image designated as PeakCD, PeakCU, PeakCR, and PeakCL. The component also includes a parameter designated as wlevelthresh which represents a window threshold for every selected peak in a projection-space image, wlevelthresh being of type float and having a range from 0 to 100. The component also includes a parameter designed as maskthreshold that represents a mask threshold of type float having a range from 0 to 1. The component also includes a parameter designed as projspacethreshold which represents a valid peak threshold in the projection-space image, projspacethreshold being of type of float and having a range from 0 to 1. The component also includes a parameter designed as areathreshold which represents an area threshold for selected valid peaks, area threshold being of type integer and having a range from 0 to 5000.

FIG. 7 is a flow diagram of an exemplary embodiment of a method 700 for selecting candidate peaks. Method 700 is an exemplary embodiment of selecting 602 candidate peaks in FIG. 6. Method 700 includes selecting 702 a window around a peak and creating 704 a mask from the window. In some exemplary embodiments of selecting 702 a window around a peak, a window of pixels (from original projection space PCD, PCU, PCR, and PCL) around the peak (in the MPCD, MPCU, MPCR, and MPCL) is selected using the following criterion: All pixel values within the window must be greater than (PeakPspace/wlevelthresh) where PeakPspace is the projection-space magnitude of the peak and wlevelthresh is a parameter.

In some exemplary embodiments of creating 704 a mask, the window selected in step 702 is normalized by dividing all its values by its maximum value. The window is a threshold to generate a binary mask window. This threshold is defined by the maskthreshold parameter. Pixels in the window with magnitudes above the maskthreshold parameter are set to a value of one, while pixels below this threshold are set to a value of zero.

Thereafter, method 700 includes eroding 706 the mask. In an exemplary embodiment of eroding 506 the mask, to correct area calculation, only the area connected to the peak under consideration is be used. This is assured by performing morphological erosion on the binary mask. Erosion causes an object to shrink the amount or the way that the object is shrunk depends on the structuring element. Erosion is defined in Table 8 below:

TABLE 8
E(A,B) = ∩_{β\B}(A − β) where, − B = {−β | β \ B}.

In Table 8, A is the image and B is the structuring element. Accordingly, a square structuring element is used as shown in Table 9 below:

TABLE 9

| | |
|---|---|
| 1 | 1 |
| 1 | 1 |

In Table 9, a structuring element for erosion has origin in the top left quadrant. Erosion can be implemented as follows: For every pixel of the mask window with mask value of 1, three points neighboring the pixel are selected according to the above structuring element. If all the above neighbors are of binary value one, then the pixel under consideration is retained, else it is removed (set to zero in the mask).

Thereafter, method 700 includes calculating 708 an area measure of the eroded mask. In some exemplary embodiments of calculating 708 the area measure, the area measure (in pixels) is calculated by summing up all mask values. Therein, only mask pixels with value of 1 will contribute to sum.

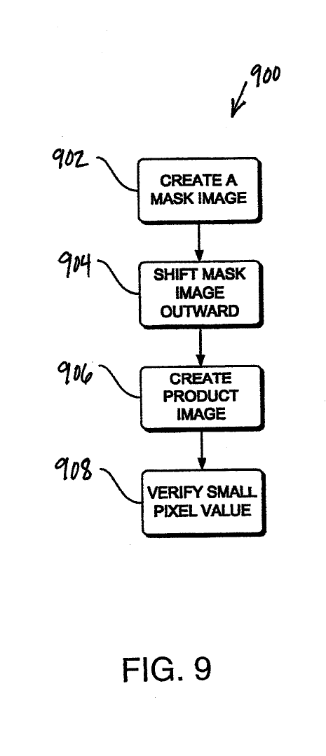

FIG. 8 is a flow diagram of an exemplary embodiment of a method 800 for determining the validity of each of the candidate collimation edges. Method 800 is an exemplary embodiment of determining 404 the validity of candidate collimation edges discussed in FIG. 4. Method 800 includes testing 802 the validity of a plurality of candidate collimation edges for each side. An exemplary embodiment of testing 802 the validity of a plurality of candidate collimation edges for each side is shown in FIG. 9. Method 800 also includes calculating 804 intersection points of lines representing collimation edges. Some exemplary embodiments of calculating 804 intersection points include creating equations of the form Ax+By=C corresponding to collimation edges and simultaneously solving each pair of equations corresponding to adjacent image sides. A, B and C represent constants and x and y represent values along the X and Y axis, respectively, of a Cartesian graph.

In the situation where the lower collimation edge is not present, X is set to the maximum limit of the X axis. In the situation where upper collimation edge is not present, X is set to the minimum limit of X axis. In the situation where the right-side collimation edge is not present, Y is set to the maximum limit of Y axis. In the situation where the left-side collimation edge is not present, Y is set the minimum limit of Y axis.

Thereafter, the coordinates of the intersection points are translated back to that of the original (unshrunk) image IM P1, P2, P3 and P4.

FIG. 9 is a flow diagram of an exemplary embodiment of a method 900 for testing the validity of a candidate collimation edge. Method 900 is an exemplary embodiment of a method of testing 802 the validity of a candidate collimation edge discussed in FIG. 8. Method 900 includes creating 902 a mask image for each candidate edge. In some exemplary embodiments each mask image is created being dependent on the position of each candidate line and on the collimation edge it represents. For example, in a collimator down mask image, pixels below the collimator down candidate line are set to a value of one and all other pixels are set to a value of zero. Similarly, in a collimator right mask image, pixels to the right of the collimator right candidate line are set to a value of one and all other pixels are set to a value of zero, and so forth. Method 900 also includes shifting 904 outward each mask image. In some exemplary embodiments, each mask image is shifted outwards by a number of pixels represented by a parameter designed as pixelshift. This accounts for a dispersion, which might be present in the image around the collimation edges. Outwards is downward for MCD, upward for MCU, towards the right for MCR, and towards the left for MCL. In some exemplary embodiments method 900 also includes four product images of these mask images and the input image 204 are created by pixel by pixel multiplication of each mask with M, MCD, MCU, MCR, and MCL. Method 900 also includes using 906 the mask to distinguish collimated area from uncollimated area in image and verifying 908 that a maximum pixel value in a corresponding collimated area is small in comparison to pixel values in uncollimated areas. In some exemplary embodiments of verifying 908 includes calculating the following image statistics: M_upper=average of upper RRThresh percentile values in image, where RRThresh is a parameter, M_lower=average of lowest LowVals values in image; and linedecision=RangeThresh*(M_upper−M_lower)+M_lower, where RangeThresh is a parameter. A candidate edge is considered valid if the maximum value in its corresponding masked image is less than linedecision. All candidate edges not satisfying this criterion are considered invalid. In some exemplary embodiments, a component that performs method 900 of testing validity of a candidate collimation edge receives edge equations in image space for the four candidate collimation edge lines and generates edge equations in image space for the valid candidate collimation edge lines. The component also includes parameter designated RRThresh which represents a percentile of image values defining ceiling being of type integer and having a range from 0 to 100, a parameter designated Rangethresh that represents a fraction of range to be considered being of type float and having a range: from 0 to 1.

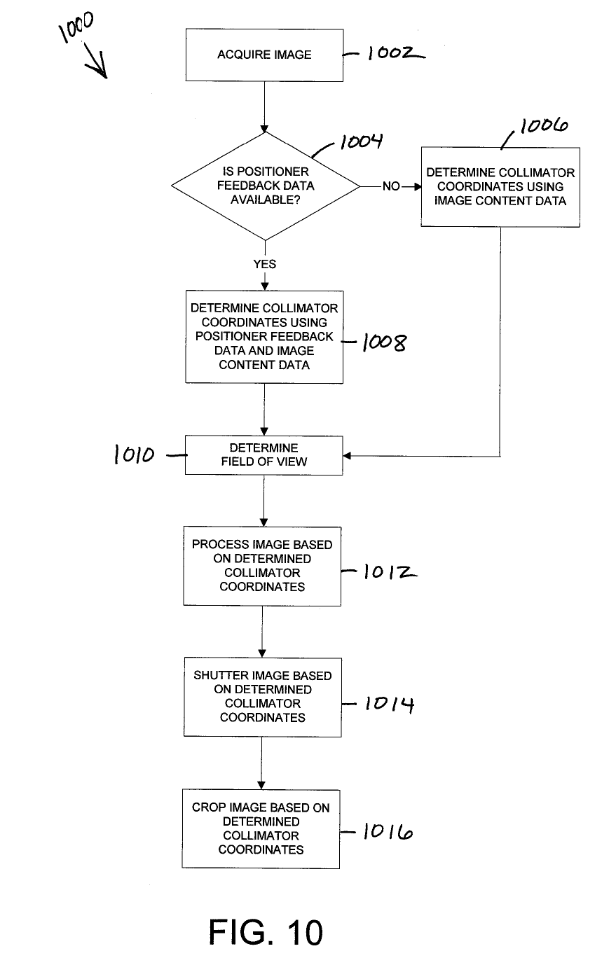

FIG. 10 is a flow diagram of an exemplary embodiment of a method 1000 to determine the exposed field of view in an X-ray radiograph. The method 1000 comprises acquiring an image of a subject from a radiography system 1002, and accessing the raw image data from the detector. Step 1004 includes determining if positioner feedback data is available from the positioner of the radiography system. If positioner feedback data is not available, then the method includes step 1006 of determining the collimator coordinates using image content data. If positioner feedback data is available, then the method includes step 1008 of determining the collimator coordinates using image content data and positioner feedback data. Step 1010 includes determining the exposed field of view of the image based on the determined collimator coordinates. The method further includes step 1012 of processing the raw image data based on the determined collimator coordinates. Step 1014 includes shuttering the image based on the determined collimator coordinates. In an exemplary embodiment, the shuttering may be accomplished by manual shuttering or automatic shuttering. The method further includes step 1016 of cropping the image based on the determined collimator coordinates.

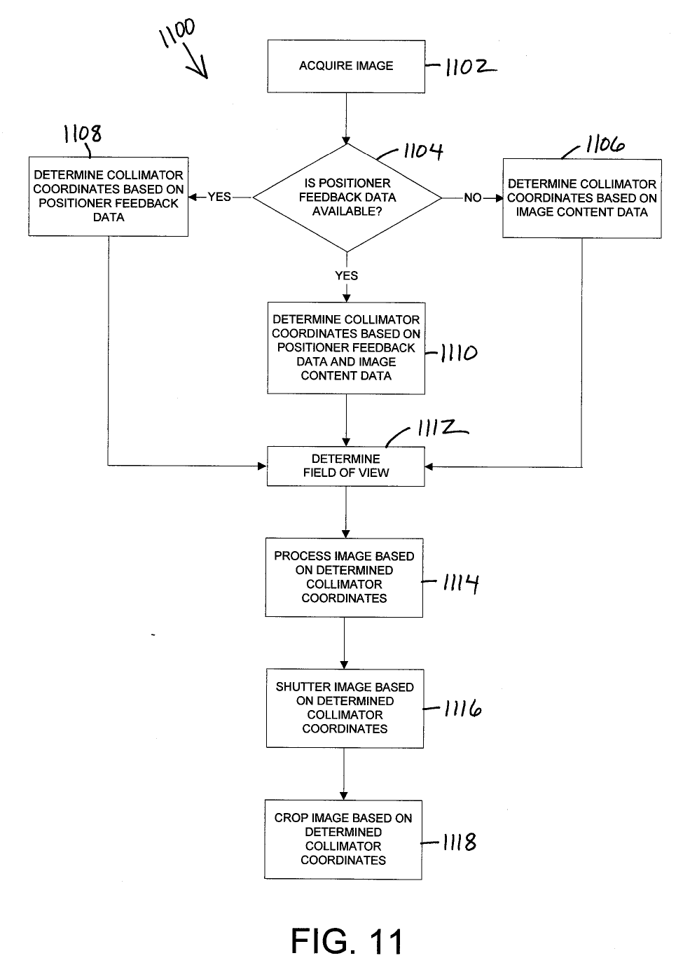

FIG. 11 is a flow diagram of an exemplary embodiment of a method 1100 to determine the exposed field of view in an X-ray radiograph. The method 1100 comprises acquiring an image of a subject from a radiography system 1102, and accessing the raw image data from the detector. Step 1104 includes determining if positioner feedback data is available from the positioner of the radiography system. If positioner feedback data is not available, then the method includes step 1106 of determining the collimator coordinates based on analysis of image content data. If positioner feedback data is available, then the method includes step 1108 of determining the collimator coordinates based on positioner feedback data. In addition, if positioner feedback data is available, then the method includes step 1110 of determining the collimator coordinates based on analysis of image content data and positioner feedback data. Step 1112 includes determining the exposed field of view of the image based on the determined collimator coordinates. The method further includes step 1114 of processing the raw image data based on the determined collimator coordinates. Step 1116 includes shuttering the image based on the determined collimator coordinates. In an exemplary embodiment, the shuttering may be accomplished by manual shuttering or automatic shuttering. The method further includes step 1118 of cropping the image based on the determined collimator coordinates.

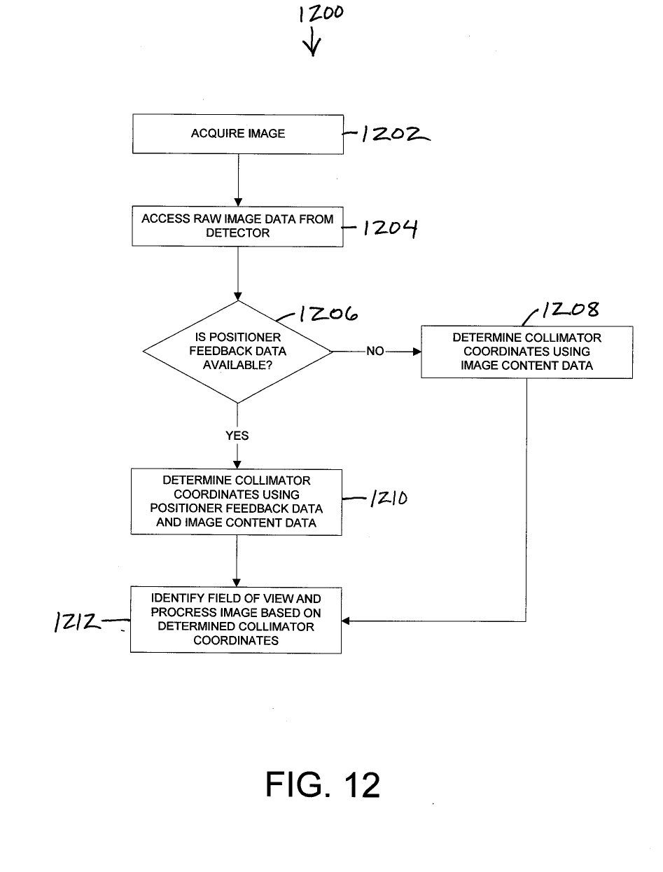

FIG. 12 is a flow diagram of an exemplary embodiment of a method 1200 to determine the exposed field of view in an X-ray radiograph. The method of determining the exposed field of view based on various parameters such as image content data, positioner feedback data, or any combination thereof, with no need for user intervention. The method 1200 comprises acquiring an image of a subject from a radiography system 1202. Step 1204 includes accessing the raw image data from the detector. Step 1206 includes determining if positioner feedback data is available from the positioner of the radiography system. If positioner feedback data is not available, then the method includes step 1208 of determining the collimator coordinates using image content data. If positioner feedback data is available, then the method includes step 1210 of determining the collimator coordinates using image content data and positioner feedback data. The method further includes step 1212 of identifying the field of view and processing the raw image based on the determined collimator coordinates.

In an exemplary embodiment, the method 1200 may further include providing image shuttering based on the determined field of view to fit the exposed region. In an exemplary embodiment, image shuttering may be accomplished by manual shuttering or automatic shuttering. In an exemplary embodiment, the method 1200 may further include providing image cropping based on the determined field of view to fit the exposed region.

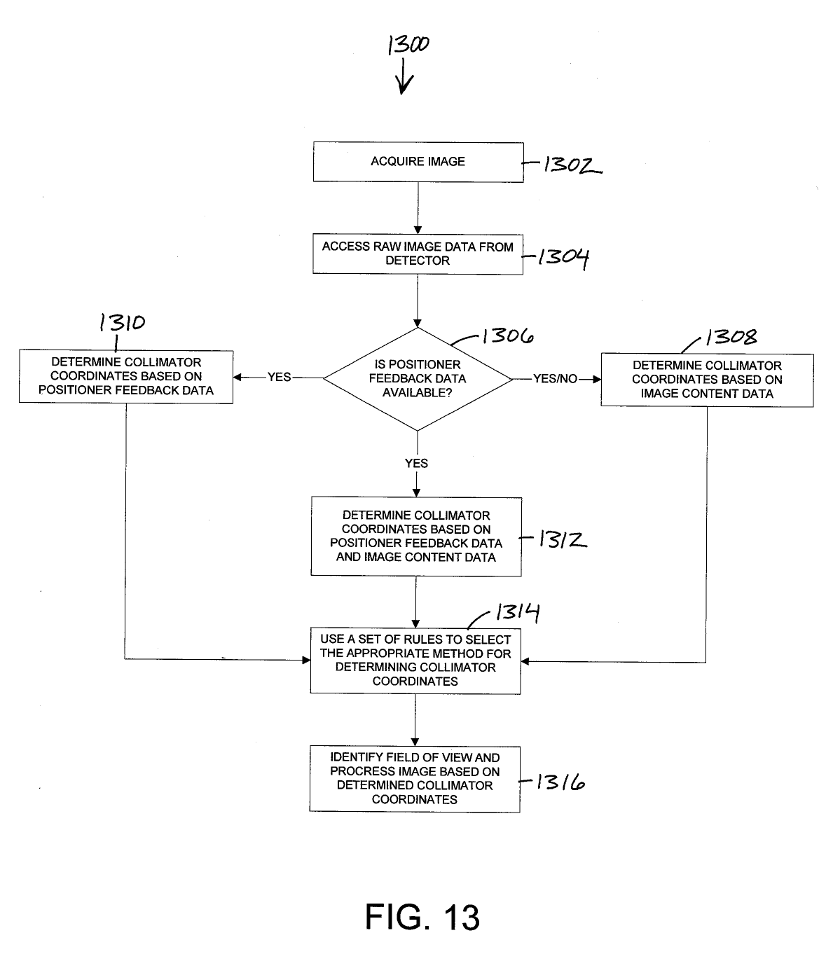

FIG. 13 is a flow diagram of an exemplary embodiment of a method 1300 to determine the exposed field of view in an X-ray radiograph. The method of determining the exposed field of view based on various parameters such as image content data, positioner feedback data, or any combination thereof, with no need for user intervention. The method 1300 comprises acquiring an image of a subject from a radiography system 1302. Step 1304 includes accessing the raw image data from the detector. Step 1306 includes determining if positioner feedback data is available from the positioner of the radiography system. If positioner feedback data is or is not available, then the method includes step 1308 of determining the collimator coordinates based on analysis of image content data. If positioner feedback data is available, then the method includes step 1310 of determining the collimator coordinates based on positioner feedback data. In addition, if positioner feedback data is available, then the method includes step 1312 of determining the collimator coordinates based on analysis of image content data and positioner feedback data. The method further includes step 1314 of using a set of rules to select the appropriate method of determining the collimator coordinates. The method further includes step 1316 of identifying the field of view and processing the raw image based on the determined collimator coordinates and field of view.

In an exemplary embodiment, the method 1300 may further include providing image shuttering based on the determined field of view to fit the exposed region. In an exemplary embodiment, image shuttering may be accomplished by manual shuttering or automatic shuttering. In an exemplary embodiment, the method 1300 may further include providing image cropping based on the determined field of view to fit the exposed region.

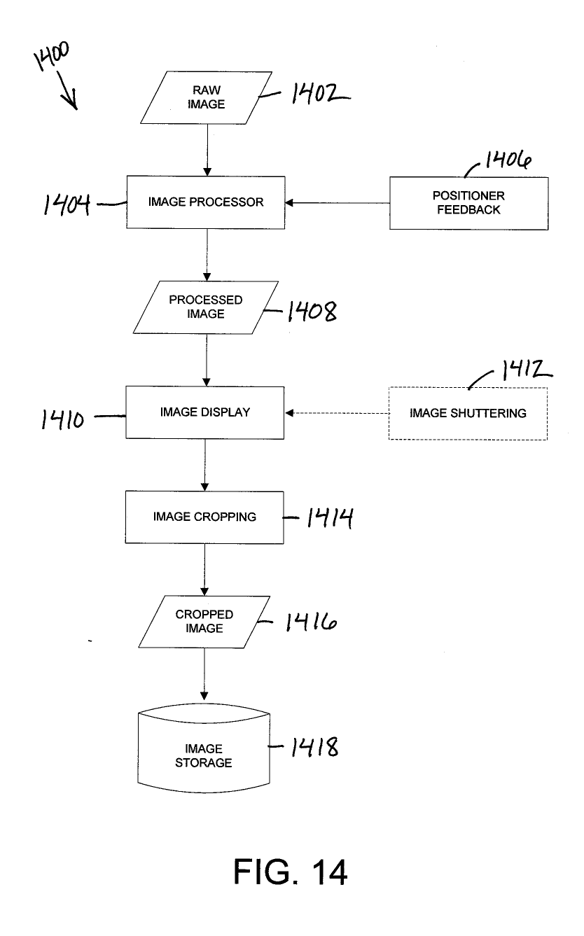

FIG. 14 illustrates an exemplary embodiment of an image processing system 1400 capable of processing an image and determining the image's field of view. The system 1400 includes an image processor 1404, a positioner 1406, a user interface 1410, and a storage device 1418. The components of the system 1400 may be implemented in software, hardware and/or firmware, for example. The components of the system 1400 may be implemented separately and/or integrated in various forms, for example.

The image processor 1404 may be configured to process raw image data to generate a processed image. The image processor 1404 determines a field of view for the raw image data for use in generating the processed image. The image processor 1404 may apply pre-processing and/or processing functions to the image data. A variety of pre-processing and processing functions are known in the art. The image processor 1404 may be used to process both raw image data and processed image data. The image processor 1404 may process a raw image to generate a processed image with a determined field of view. In an exemplary embodiment, the image processor 1404 is capable of retrieving raw image data to generate a processed image and determine a field of view. The field of view may be determined based on positioner feedback data from the positioner 1406, image content data from the raw image 1402, or any combination thereof.

The positioner 1406 receives data regarding collimator coordinates and collimation edges for input to the image processor 1404 for determining the exposed field of view of the image. The collimator coordinates and collimation edges may be determined using image content data, positioner feedback data, or any combination thereof.

The user interface 1410 having a display for viewing the processed image may be configured to allow a user to adjust the processed image with the determined field of view by providing manual image shuttering 1412. The user interface 1410 may include a keyboard driven, a mouse driven, a touch screen, or other input interface providing user-selectable options, for example.

The storage device 1418 is capable of storing images and other data. The storage device 1418 may be a memory, a picture archiving and communication system, a radiology information system, hospital information system, an image library, an archive, and/or other data storage device, for example. The storage device 1418 may be used to store the raw image and the processed image with the determined field of view, for example. In an exemplary embodiment, a processed image may be stored in association with related raw image data.

In operation, an image of a subject is acquired by an imaging apparatus, the image processor 1404 obtains image data from the imaging apparatus or an image storage device, such as storage device 1418. The image processor 1404 processes (and/or pre-processes) the image data, determining a field of view based on positioner feedback data from the positioner 1406, image content data from the raw image 1402, or any combination thereof, to yield a processed image 1408. The image processor 1404 then displays the processed image on an image display of the using the user interface 1410. A user may view the image via the user interface 1410 and execute functions with respect to the image, including saving the image, modifying the image, and/or providing image shuttering, for example.

After the field of view has been determined, the image processor 1404 may further process the image data by masking and cropping the image using the determined field of view. After processing, the image may be stored in the storage device 1418 and/or otherwise transmitted. Field of view processing may be repeated before and/or after storage of the image in the storage device 1418.

In an exemplary embodiment, the functions of image processor 1404, positioner 1406, and user interface 1410 may be implemented as instructions on a computer-readable medium. For example, the instructions may include an image processing routine, a positioner feedback routine, and a user interface routine. The image processing routine is configured to process an image based on information extracted from a determined field of view for the image. The image processing routine generates a processed image from a raw image. The positioner feedback routine is configured to access collimator coordinates and collimation edges from the X-ray source and collimator, and input that data to the image processing routine for determining the exposed field of view of the image. The user interface routine is capable of adjusting the processed image. In an embodiment, the image processing routine, the positioner feedback routine, and the user interface routine execute iteratively until a field of view is approved by a user or software. A storage routine may be used to store the raw image in association with the processed image with the determined field of view.

Several embodiments are described above with reference to drawings. These drawings illustrate certain details of specific embodiments that implement systems, methods and computer programs. However, the drawings should not be construed as imposing any limitations associated with features shown in the drawings. This disclosure contemplates methods, systems and program products on any machine-readable media for accomplishing its operations. As noted above, the embodiments of the may be implemented using an existing computer processor, or by a special purpose computer processor incorporated for this or another purpose or by a hardwired system.

As noted above, embodiments within the scope of the included program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments are described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions thereof might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

Those skilled in the art will appreciate that the embodiments disclosed herein may be applied to the formation of any radiography system. Certain features of the embodiments of the claimed subject matter have been illustrated as described herein, however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

What is claimed is:

1. A method for determining a field of view for a radiography image, the method comprising:
acquiring an image;
determining a field of view for the acquired image using image content data;
processing the acquired image based on the determined field of view; and
cropping the processed image to fit the determined field of view.

2. The method of claim 1, wherein the image content data comprises a raw image before processing.

3. A method for determining a field of view for a radiography image, the method comprising:
acquiring an image;
determining a field of view for the acquired image using positioner feedback data;
processing the acquired image based on the determined field of view; and
cropping the processed image to fit the determined field of view.

4. A method for determining a field of view for a radiography image, the method comprising:
acquiring an image;
determining a field of view for the image using image content data and positioner feedback data;
processing the acquired image based on the determined field of view; and
cropping the processed image to fit the determined field of view.

5. The method of claim 4, wherein the image content data comprises a raw image before processing.

6. A method for determining a field of view for a radiography image, the method comprising:
acquiring an image;
determining collimator coordinates for the acquired image using image content data;
determining collimator coordinates for the acquired image using positioner feedback data;
determining collimator coordinates for the acquired image using image content data and positioner feedback data;
selecting the collimator coordinates from the image content data, positioner feedback data, or a combination thereof;
processing the acquired image based on the selected collimator coordinates.

7. The method of claim 6, wherein the image content data comprises a raw image before processing.

8. A method of determining the exposed field of view in a radiography system that includes an X-ray source, a detector, and a positioner, the method comprising:
acquiring an image of a subject using the radiography system including the X-ray source, the detector and the positioner;
determining collimator coordinates for the acquired image based on one of image content data, positioner feedback data, and image content data and positioner feedback data;
using a set of rules for selecting the appropriate method of determining collimator coordinates; and
identifying the field of view and processing the image based on the determined collimator coordinates.

9. The method of claim 8, wherein the image content data comprises a raw image before processing.

10. A radiography system for determining a field of view for an image, the system comprising:
an X-ray source;
a detector;
a collimator adjacent to the X-ray source, and between the X-ray source and the detector;
a positioner coupled to the X-ray source and the collimator for controlling the positioning of the X-ray source and the collimator;
an image processor configured to process image data to generate a processed image, wherein the image processor determines a field of view for the image data based on image content data, positioner feedback data from the positioner, or any combination thereof for use in generating the processed image.

11. The system of claim 10, wherein the image processor crops the processed image based on the determined field of view.

12. A system for determining a field of view for an image, the system comprising:
an image processor configured to process image data to generate a processed image, wherein the image processor determines a field of view for the image data based on image content data, positioner feedback data, or any combination thereof for use in generating the processed image.

13. The system of claim 12, wherein the image processor crops the processed image based on the determined field of view.

14. The system of claim 12, wherein the image processor is capable of retrieving the image data to generate a processed image and determine the field of view.

15. The system of claim 12, further comprising a storage device for storing the processed image with the determined field of view.

16. The system of claim 15, wherein the storage device stores the processed image with the determined field of view and the image data, wherein the processed image data is stored in association with the image.

17. A computer-readable storage medium including a set of instructions for a computer, the set of instructions comprising:
an image processing routine configured to process image data to generate a processed image, wherein the image processor determines a field of view for the image data based on image content data, positioner feedback data, or any combination thereof for use in generating the processed image.

18. The set of instructions of claim 17, wherein the image processing routine processes the image based on the determined field of view for the image.

19. The set of instructions of claim 17, wherein the image processing routine generates a processed image from an image, and further comprising a storage routine for storing the raw image in association with the processed image with the determined field of view.
